(19) United States
(12) Patent Application Publication
(10) Pub. No.: US 2026/0092435 A1
(43) Pub. Date: Apr. 2, 2026

(54) FAUCET HANDLE WITH LOCK

(71) Applicant: Kohler Co., Kohler, WI (US)

(72) Inventors: Peyton Norton, Kohler, WI (US); Rodney Weekley, Kohler, WI (US); Scott Brown, Kohler, WI (US)

(21) Appl. No.: 19/344,712

(22) Filed: Sep. 30, 2025

Related U.S. Application Data
(60) Provisional application No. 63/701,818, filed on Oct. 1, 2024.

(51) Int. Cl. E03C 1/04; F16K 35/02

(52) U.S. Cl. CPC E03C 1/0412; E03C 1/041; F16K 35/025

(57) ABSTRACT

Provided herein is a faucet. The faucet includes a handle for controlling operation of the faucet and an outlet for providing water to a user. When the user presses the handle in one of a downward direction or inward direction, the handle is unlocked. When the handle is unlocked, the user can rotate the handle. When the handle is rotated, water may flow out of the outlet. When the user releases the handle, the handle returns to a locked position.

### CROSS-REFERENCE TO RELATED APPLICATIONS

The present application claims priority to U.S. Provisional Patent Application No. 63/701,818, filed October 1, 2024, entitled, “FAUCET HANDLE WITH LOCK,” the entire contents of which is hereby incorporated by reference.

### BACKGROUND

Instant hot water faucets, which provide hot water for users, are desirable for many uses, including in the kitchen. These faucets provide hot water on demand for a user. This may provide convenience to users needing hot water, including making coffee or tea or for cleaning needs.

### BRIEF DESCRIPTION OF DRAWINGS

FIG. 1 is a perspective view of a first example faucet.

FIG. 2 is a first cross-sectional view of a second example faucet.

FIG. 3 is a second cross-sectional view of the second example faucet.

FIG. 4 is a first cross-sectional view of a third example faucet.

FIG. 5 is a second cross-sectional view of the third example faucet.

FIG. 6 is a perspective view of a fourth example faucet.

While the disclosure is susceptible to various modifications and alternative forms, a specific embodiment thereof is shown by way of example in the drawings and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

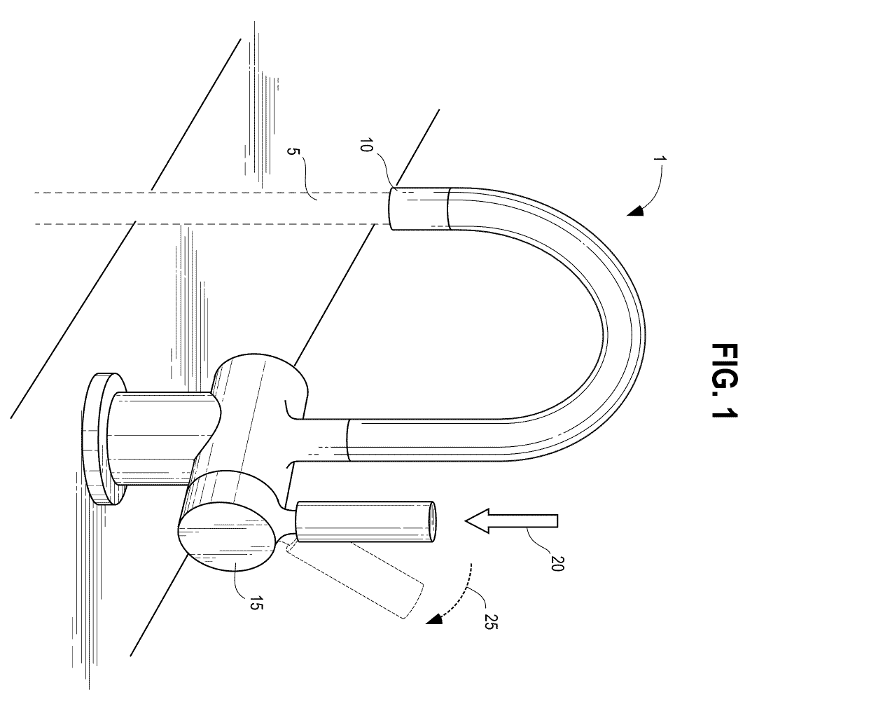

Turning first to FIG. 1, a faucet 1 may provide fluid (e.g., water) in an outlet stream 5 via an outlet 10. The faucet 1 may be used, such that when water is delivered as the outlet stream 5 via the outlet 10, the water may be hot (which may be useful for cooking, cleaning, or making hot beverages). To use the faucet 1, a user may press down on a handle 15 in a direction illustrated by arrow 20 (e.g., downward) to unlock the faucet 1 for use. After the handle 15 is unlocked, the user may rotate the handle 15 in a direction illustrated by arrow 25 (e.g., backward or forward) in order to cause water to flow out of the outlet 10. The locking capabilities may enhance safety and may be useful such that hot water may not exit the faucet 1 before the handle 15 is unlocked and rotated. Although discussed with reference to movement in particular directions, it should be understood that any direction may be used, and the faucet 1 may be unlocked when it is pushed downward, inward, upward, outward, backward, forward, etc.

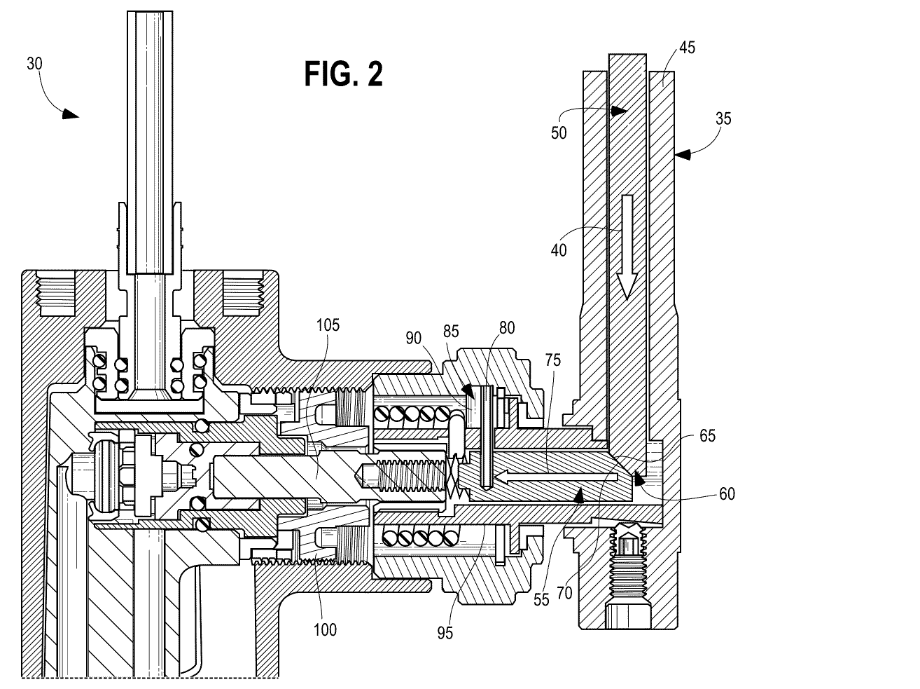

As set forth in FIG. 2, a faucet 30 (which may be similar to the faucet 1 of FIG. 1) may include a handle 35 (which may be similar to the handle 15 of Fig .1). A user may press down on the handle 35 in a direction illustrated by arrow 40 (e.g., downward). An interior 45 of the handle 35 may include an elongate portion 50 which may engage with a valve engagement member 55. A base end 60 of the elongate portion 50 may be angled on an inner side 65, and the angle of the inner side 65 on the base end 60 may engage with an angled portion 70 of the valve engagement member 55. When the handle 35 is pushed down in the direction illustrated by arrow 40, the elongate portion 50 may translate in the direction illustrated by arrow 40. When translated downward, the inner side 65 of the elongate portion 50 may be guided along the angled portion 70 of the valve engagement member 55. Such translation of the elongate portion 50 may cause the valve engagement member 55 to translate in a direction illustrated by arrow 75.

The valve engagement member 55 may be integrated with or connected to a pin 80. The pin 80 may be positioned near an opposite end to the angled portion 70 of the valve engagement member 55. When the valve engagement member 55 translates, the pin 80 may adjust within a locking zone 85. As illustrated, the pin 80 may be in a first position, and the handle 35 may be locked. However, the pin 80 may adjust toward an inner wall 90 in the locking zone 85. When the pin 80 abuts the inner wall 90, the handle 35 may be unlocked, such that a user may rotate the handle 35 in a direction toward or away from themselves. The rotation may cause the pin 80 and thus a rotatable portion 95 in a body 100 of the faucet 1 to rotate. When unlocked and the rotatable portion 95 is rotated, a valve 105 may open and may cause water to flow out of the faucet 30.

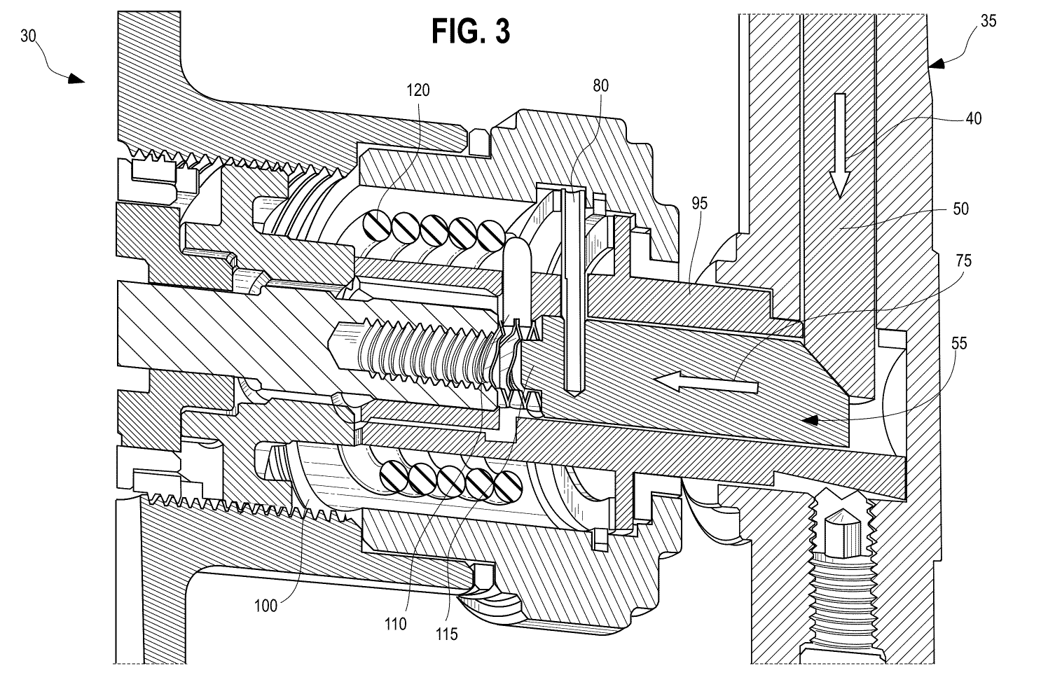

As illustrated in FIG. 3, a pin spring 110 may bias the pin 80 to a locked position. The pin spring 110 may be a tension spring or other spring suitable for the design. The pin spring 110 may be used to return the pin 80 (and thus, the handle 35) to a locked position when the handle 35 is not pressed down. The pin spring 110 may be integrated with or connected to an end 115 of the valve engagement member 55. A valve engagement member spring 120 may be positioned around the rotatable portion 95 in the body 100 of the faucet 30. The valve engagement member spring 120 may bias the valve engagement member 55 in an opposite direction of arrow 75, which thus biases the elongate portion 50 in an opposite direction of arrow 40. Such bias may cause the handle 35 to return to a locked position. When a user releases the handle 35 and/or the handle 35 is not activated in the manner as described herein, the handle 35 may return to an “off” position. Such return may be referred to as an “auto-shutoff,” such that water may not exit the faucet 30.

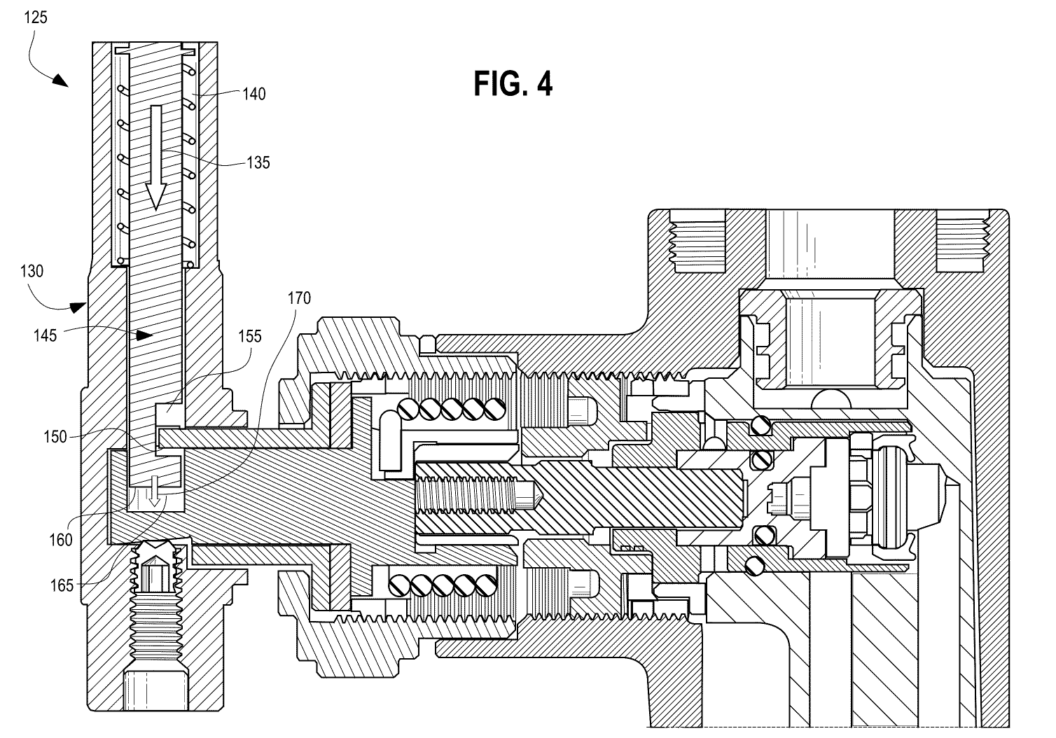

Turning now to FIG. 4, a faucet 125 (which may be similar to the faucet 1 and faucet 30 of FIG. 1 and FIGS. 2-3, respectively) may include a handle 130 (which may be similar to the handle 15 and handle 35 of FIG. 1 and FIGS. 2-3, respectively). A user may press down on the handle 130 in a direction illustrated by arrow 135. An interior 140 of the handle 130 may include an elongate portion 145, which may be translated in a direction illustrated by arrow 135. When translated, a notch 150 in the elongate portion 145 may adjust within an adjustment zone 155, and an end 160 of the elongate portion 145 may adjust within a clearance portion 165 in a direction illustrated by arrow 170.

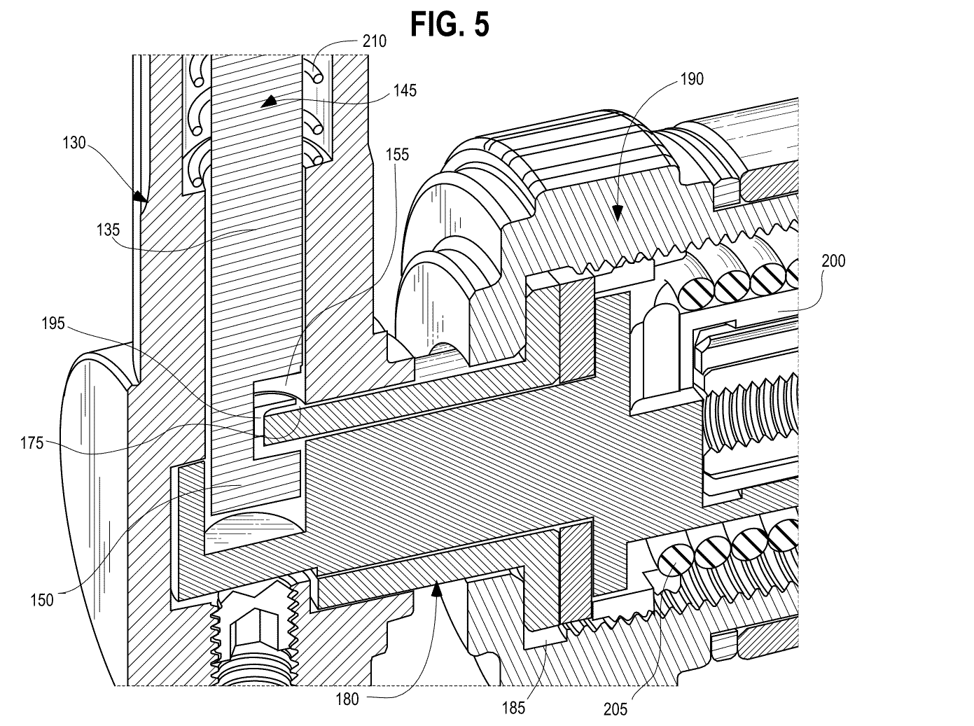

As illustrated in FIG. 5, when in a first position, an outer edge 175 of a rotatable portion 180 within an interior 185 of a body 190 of the faucet 125 may abut a locking wall 195 such that the rotatable portion 180 may not rotate within the body 190. When the notch 150 adjusts in the adjustment zone 155, a rotatable portion 180 may be “unlocked” such that the outer edge 175 may not be blocked from movement by the locking wall 195. As such, when a user rotates the handle 130 in a direction toward or away from themselves, the rotatable portion 180 may rotate. When unlocked and the rotatable portion 180 is rotated, a valve 200 may open and may cause water to flow out of the faucet 125.

A first elongate portion spring 205 may bias the elongate portion 145 to a locked position. The first elongate portion spring 205 may be a tension spring or other spring suitable for the design. The first elongate portion spring 205 may be used to return the elongate portion 145 (and thus, the handle 130) to a locked position when the handle 130 is not pressed down. The first elongate portion spring 205 may be integrated with or connected to the rotatable portion 180 and may be positioned around the rotatable portion 180. A second elongate portion spring 210 may bias the elongate portion 145 in an opposite direction of arrow 135. Such bias may cause the handle 130 to return to a locked position. When a user releases the handle 130 and/or the handle 130 is not activated in the manner as described herein, the handle 130 may return to an “off” position. Such return may be referred to as an “auto-shutoff,” such that water may not exit the faucet 125.

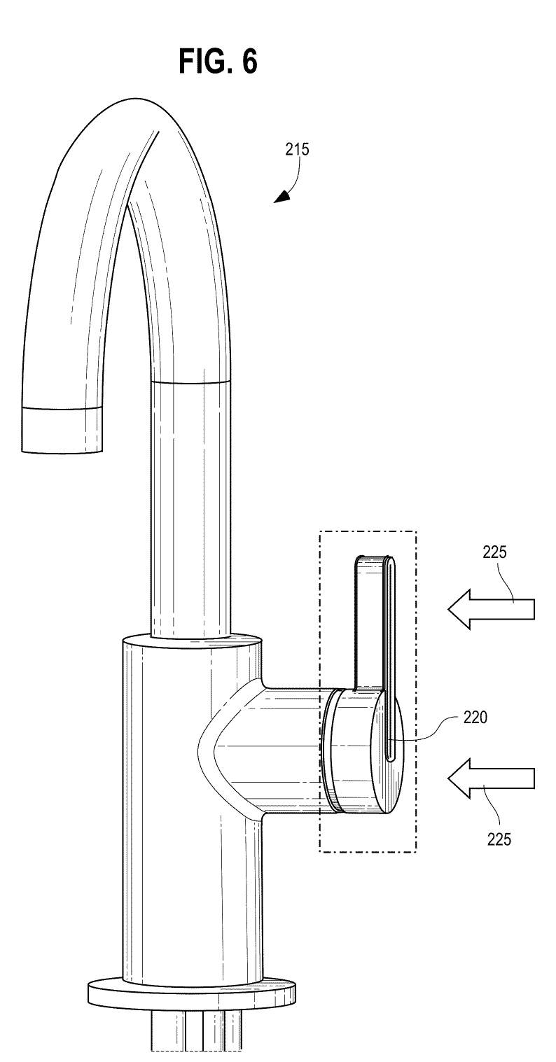

Turning now to FIG. 6, a faucet 215 (which may be similar to the faucet 1, faucet 30, and faucet 125 of FIG. 1, FIGS. 2-3, and FIGS. 4-5, respectively) may include a handle 220 (which may be similar to the handle 15, handle 35, and handle 130 of FIG. 1, FIGS. 2-3, and FIGS. 4-5, respectively). A user may press the handle 220 in a direction illustrated by arrows 25. When pressed in such direction, the user may rotate the handle 220 to cause water to flow out of the faucet 215. When a user lets go of the handle 220 and/or does not press the handle 220 in the direction illustrated by arrows 225, the handle 220 may be reset such that it may be “locked” and may not be rotated.

The present disclosure is disclosed in the context of faucets but not limited to faucets. Aspects of the present disclosure that are depicted in the illustrated embodiments or otherwise described herein may be used in conjunction with other ablutionary fittings or water distribution systems. Water distribution systems encompassed by the present disclosure include, without limitation, water distribution systems that dispense water for consumption and/or washing and water distribution systems used for private, public, domestic, residential, commercial, and/or industrial use. Water distribution systems such as, for example and without limitation, showers, baths, washtubs, hot tubs, sinks, fountains, water dispensers, and the like may incorporate aspects of the present disclosure and are encompassed herein. Example water distribution systems may include an outlet dispensing water or other fluid. The outlet may include any suitable device that is configured to dispense liquid or water. The outlet may include an ablutionary fitting, such as, for example and without limitation, a showerhead, shower spray, wand hand shower, faucet, wand, spigot, tap, spout, or the like. The outlet can include a single outlet or more than one outlet. Where the outlet includes multiple, e.g., two or more outlets, the outlets can be similar types of outlets or dissimilar types of outlets. Elements and features described with reference to one illustrated embodiment are not limited to that embodiment only; the features and elements of any one or more of the illustrated embodiments can be utilized in any other embodiment in any combination.

As is evident from the foregoing description, certain aspects of the present invention are not limited by the particular details of the examples illustrated herein, and it is therefore contemplated that other modifications, applications, variations, or equivalents thereof, will occur to those skilled in the art. Many such changes, modifications, variations, and other uses and applications of the present constructions will, however, become apparent to those skilled in the art after considering the specification and the accompanying drawings. In addition, unless mention was made above to the contrary, it should be noted that all of the accompanying drawings are not to scale. All such changes, modifications, variations, and other uses and applications which do not depart from the spirit and scope of the present inventions are deemed to be covered by the inventions which are limited only by the claims which follow.

1. A faucet comprising:
a handle for controlling operation of the faucet, wherein the handle is in one of a locked position or an unlocked position;
an outlet for providing water out of the faucet; and
a valve for controlling an amount of water provided to the outlet;
wherein, when the handle is in the unlocked position, the handle is rotatable; and
wherein, when the handle is rotated, the valve is opened such that water may flow out of the faucet via the outlet.

2. The faucet of claim 1, wherein, when the handle is pressed in one of a downward direction or inward direction, the handle is in the unlocked position.

3. The faucet of claim 1, wherein, when the handle is released, the handle returns to the locked position.

4. The faucet of claim 1, further comprising a valve engagement member spring biasing the handle to the locked position.

5. The faucet of claim 1, wherein an interior of the handle comprises an elongate portion engageable with a valve engagement member of the faucet.

6. The faucet of claim 5, wherein, when the handle is pressed in one of a downward direction or inward direction, the elongate portion translates in the downward direction and guides along an angled portion of the valve engagement member.

7. The faucet of claim 5, wherein translation of the elongate portion causes the valve engagement member to translate laterally in a direction toward the valve, causing the valve to open.

8. The faucet of claim 1, further comprising:
a pin connected to a valve engagement member and located within a locking zone; and
a pin spring biasing the pin to a first position within the locking zone;
wherein, when the pin is in the first position, the handle is in the locked position; and
wherein, when the pin is in a second position within the locking zone, the handle is in the unlocked position.

9. A faucet comprising:
a handle for controlling operation of the faucet, wherein the handle is in one of a locked position or an unlocked position;
wherein the handle is biased to the locked position;
wherein operating the faucet controls an amount of water provided via the faucet;
wherein, when the handle is in the unlocked position, the handle is rotatable; and
wherein, when the handle is rotated, water may flow out of the faucet.

10.The faucet of claim 9, wherein, when the handle is pressed in one of a downward direction or inward direction, the handle is in the unlocked position.

11. The faucet of claim 9, wherein, when the handle is released, the handle returns to the locked position.

12. The faucet of claim 9, further comprising a valve engagement member spring biasing the handle to the locked position.

13. The faucet of claim 9, wherein an interior of the handle comprises an elongate portion engageable with a valve engagement member of the faucet.

14. The faucet of claim 13, wherein, when the handle is pressed in one of a downward direction or inward direction, the elongate portion translates in the downward direction.

15. The faucet of claim 14, wherein, when the elongate portion translates in the downward direction, a notch in the elongate portion adjusts within an adjustment zone, and an end of the elongate portion adjusts within a clearance portion in the downward direction, causing a valve of the faucet to open.

16. The faucet of claim 15, wherein, when the notch adjusts in the adjustment zone, a rotatable portion is unlocked, allowing the handle to rotate.

17. A faucet comprising:
a rotatable handle for controlling operation of the faucet, wherein the rotatable handle is in one of a locked position or an unlocked position; and
an outlet for providing water out of the faucet; and
a valve for controlling an amount of water provided to the outlet.

18. The faucet of claim 17, wherein, when the rotatable handle is in the unlocked position and the rotatable handle is rotated, the valve is open, causing water to flow out of the faucet via the outlet.

19. The faucet of claim 17, wherein, when the rotatable handle is pressed in one of a downward direction or inward direction, the rotatable handle is in the unlocked position.

20. The faucet of claim 17, wherein, when the rotatable handle is released, the rotatable handle returns to the locked position.
